(19) United States
(12) Patent Application Publication
(10) Pub. No.: US 2026/0310258 A1
(43) Pub. Date: Oct. 8, 2026

(54) PORTABLE COMPANION DEVICE FOR SECURITY, ENERGY, AND GLOBAL COMMUNICATIONS

(71) Applicant: R3DI INDUSTRIES, INC., Santa Ana, CA (US)

(72) Inventor: Rayford Higginbotham, Ladera Ranch, CA (US)

(21) Appl. No.: 19/638,937

(22) Filed: Apr. 3, 2026

Related U.S. Application Data
(60) Provisional application No. 63/784,013, filed on Apr. 5, 2025.

(51) Int. Cl. G06F 1/16; G06F 1/26; H02J 7/70

(52) U.S. Cl. CPC G06F 1/1635; G06F 1/266; H02J 7/731

(57) ABSTRACT

Portable companion devices and systems for security, energy, and global communications are provided. The device may include a battery system of at least one kilowatt-hour, capable of delivering power through multiple output formats, and is rechargeable via alternator, AC/DC, or solar input. It may integrate communications technologies including cellular, Wi-Fi, Bluetooth, LoRaWAN, satellite, and GPS, along with a central CPU for artificial intelligence processing and remote diagnostics. Additional features may include smart and thermal camera systems, a suite of environmental sensors, internal cooling, lighting with SOS capability, and ruggedized construction using RF-permissive and impact-resistant materials. The device may be mountable using a universal tray system and is fully waterproof and buoyant for deployment in extreme conditions.

### RELATED APPLICATIONS

This application claims the benefit of the filing date of U.S. Provisional Patent Application, Ser. No. 63/784,013, filed on Apr. 5, 2025, the disclosure of which is incorporated herein by reference in its entirety.

### FIELD OF THE INVENTION

This patent document relates to the fields of portable electronics and multifunctional mobile platforms. More specifically, it pertains to a self-contained, ruggedized device that integrates energy storage, generation and distribution, global communications and transactions, security surveillance, artificial intelligence processing, environmental and situational awareness into a single compact unit intended for portable or field-deployable use.

### DESCRIPTION OF THE RELATED ART

Conventional portable power stations and communication systems typically focus on a single primary function-such as providing electrical backup, enabling radio or satellite communications, or offering lighting in field environments. These devices are often specialized, lack integration, and require users to carry multiple systems to meet basic field operation needs. For example, portable batteries or generators may provide electrical power but lack any onboard communication, surveillance, or AI capabilities. Separate GPS modules, Wi-Fi routers, radios, and ruggedized laptops are commonly employed in remote settings but are prone to incompatibility, interconnection failure, and complex setup. In military and emergency response contexts, the use of multiple tools introduces operational delays, increased risk of equipment failure, and additional training requirements. This fragmentation of tools undermines efficiency in time-critical environments.

Some attempts have been made to create multifunction devices, but these are typically limited in scope. For example, certain commercial drone docking stations or vehicle-mounted base stations include combined lighting, power, or Wi-Fi capabilities, but are either bulky, immobile, or unsuitable for personal transport. Others require external network infrastructure, lack AI processing capability, or do not support autonomous power management. This leads to operational inefficiencies, added weight, and increased logistical complexity.

Additionally, known systems fail to provide modular, IP67-rated, AI-enabled solutions that combine field-ready communications, intelligent surveillance, environmental awareness, and ruggedized power supply in one easily deployable and mountable unit. The art lacks a compact, wearable, or vehicle-compatible multifunctional system that integrates battery storage, edge computing, real-time sensor processing, multi-band communications, and threat detection in both urban and off-grid scenarios.

Accordingly, there remains a need for a compact, integrated, and rugged device that bridges the gap between power supply, communications, sensing, and environmental interaction-particularly for self-defense, emergency response, industrial operations, and mobile civilian use. The present invention addresses these deficiencies and provides a novel, integrated solution capable of delivering continuous security, backup power, smart sensing, and global communication.

### SUMMARY

Portable companion devices for security, energy, and global communications are provided. In one embodiment, a portable device is configured to serve as a personal or deployable companion system that provides a continuous power supply, global data and voice communication, integrated artificial intelligence, and surveillance capabilities. The device includes a rechargeable battery system with a storage capacity of at least one kilowatt-hour, rechargeable via internal alternator mechanisms, solar input, or AC/DC external power sources. It offers multiple output formats including USB, PoE, and AC receptacles, enabling it to power and recharge a wide range of external devices.

The device may include a microprocessor with built-in memory and storage for data processing and AI-driven operations, including remote diagnostics and control via cloud-connected applications. Communication hardware supports a full spectrum of modern connectivity technologies, including cellular (4G/5G), Wi-Fi, Bluetooth, LoRaWAN, GPS, and satellite transmission. A built-in speaker and microphone system may be used to support real-time audio functionality. Integrated imaging modules may include smart and thermal cameras that support object recognition, weapons detection, and ambient intelligence, with both fixed and detachable configurations. These modules interface with the onboard AI system for threat detection and environmental analysis.

The device may also include environmental sensors such as motion detectors, gyroscopes, accelerometers, proximity sensors, and lidar modules, enabling the device to interact with its surroundings in an intelligent and responsive manner. An LCD user interface may be used to provide status readouts and system control. In one embodiment, the device may include a built-in lighting system with an SOS signaling capability, as well as a modular Wi-Fi range extender that supports a mesh network or daisy-chain expansion for extended coverage. Internal components may be temperature-regulated using a fan and HVAC system to ensure operational efficiency across extreme environments.

In one embodiment, the outer shell of the device may be formed from impact-resistant materials including polycarbonate and Kevlar, which also support RF signal transmission. Additional layers may include D30 smart foam and interior ABS barriers to provide both strength and shock absorption. The structural design may incorporate an aluminum alloy frame system. External shell may have universal MOLLE-compatible or other universal mounting mechanisms, mounting points, allowing the device to be worn, carried, or affixed to land, air, or sea vehicles, buildings, or static installations. The unit may also be sealed for waterproofing, weather resistance, and buoyancy, allowing for deployment in both dry and wet field conditions.

Each of the foregoing various aspects, together with those set forth in the claims and described in connection with the embodiments summarized above and disclosed herein may be combined to form claims for a device, apparatus, system, methods of manufacture and/or use in any way disclosed herein without limitation.

### BRIEF DESCRIPTION OF THE DRAWINGS

These and other features, aspects and advantages are described below with reference to the drawings, which are intended to illustrate but not to limit the invention. In the drawings, like reference characters denote corresponding features consistently throughout similar embodiments.

FIG. 1A illustrates a perspective cutaway view of the device in a closed and transportable configuration.

FIG. 1B shows a side view of the device of FIG. 1A.

FIG. 2 shows an exploded view of the device of FIG. 1A, revealing the internal arrangement of primary components including the battery, CPU, inverter, and input/output ports.

FIG. 3 is a block diagram of the device of FIG. 1A, showing power and data flow across major subsystems.

FIG. 4 displays a camera system for use with the device of FIG. 1A, including smart and thermal imaging units in deployed position.

FIG. 5 depicts the user interface panel, lighting module, and sensor layout of the device of FIG. 1A.

FIG. 6 details a mounting structure using the universal MOLLE tray system, for use with the device of FIG. 1A.

FIG. 7 illustrates a top-down schematic of sensor and antenna locations of the device of FIG. 1A.

FIG. 8 illustrates a perspective view of another embodiment of device like that of FIG. 1A.

FIG. 9 is a top view of the device of FIG. 8.

FIG. 10 is an exploded view of the device of FIG. 8.

FIG. 11 is a partial perspective view of the device of FIG. 8.

FIG. 12 is a close-up view of the display of the device of FIG. 8.

FIG. 13 is a partial side-view of the device of FIG. 8.

### DETAILED DESCRIPTION

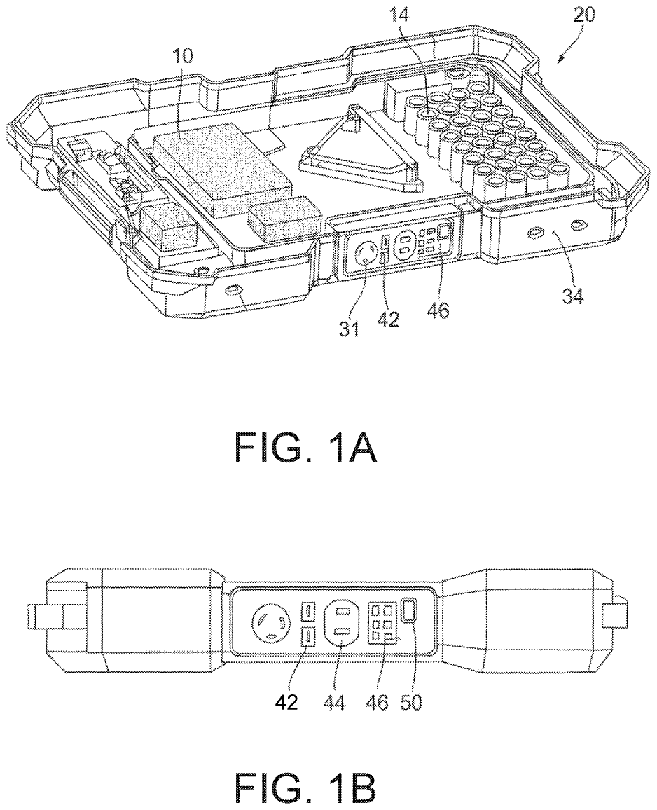

Unique and inventive portable companion devices for security, energy, and global communications are disclosed herein. In one embodiment, the invention comprises a ruggedized, portable device encased in a sealed housing. FIG. 1 illustrates the external configuration of the device 20, including the outer shell 12, which may in an embodiment preferably be molded of polycarbonate and Kevlar, and a handle for transport. The external enclosure is dimensioned for handheld use and sealed for water resistance and buoyancy. The front panel preferably includes a status interface display, camera module, and multiple ports 31, 42, 44, 46, and 50 enclosed by a weatherproof cover. An LED lighting strip 34 is preferably provided and positioned for example along the top edge to provide both general illumination and emergency SOS signaling.

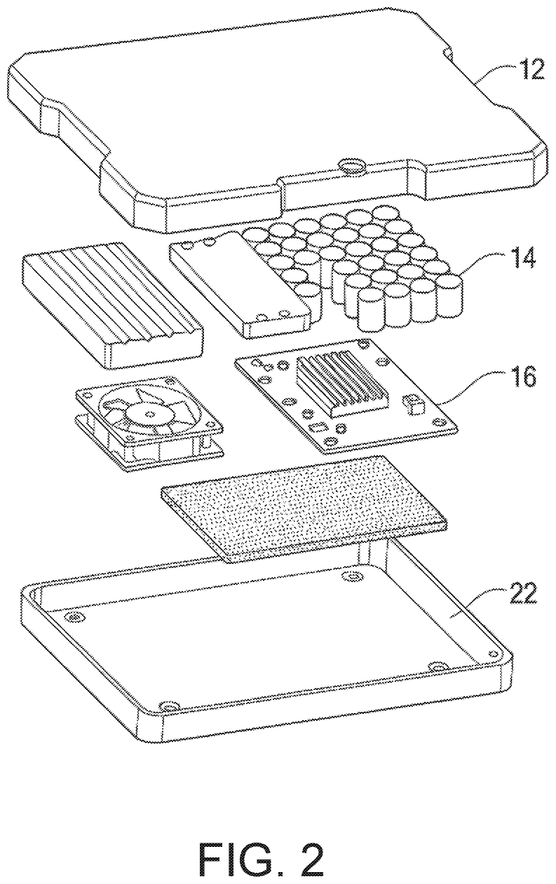

FIG. 2 provides an exploded view of an exemplary device, showing its layered assembly. Internally, the unit includes a battery pack 14 consisting for example of LifePO4 cells having a minimum total capacity of one kilowatt-hour, a central processing unit, memory modules, and an inverter preferably an integrated sine wave power inverter. A thermal regulation fan is preferably mounted adjacent to the battery and controlled by an HVAC circuit. The internal electronics are preferably shielded with RF-permissive polycarbonate panels and preferably further protected with D30 smart foam inserts 10. Component compartments are preferably organized on an aluminum alloy chassis 22 for thermal conduction and mounting stability.

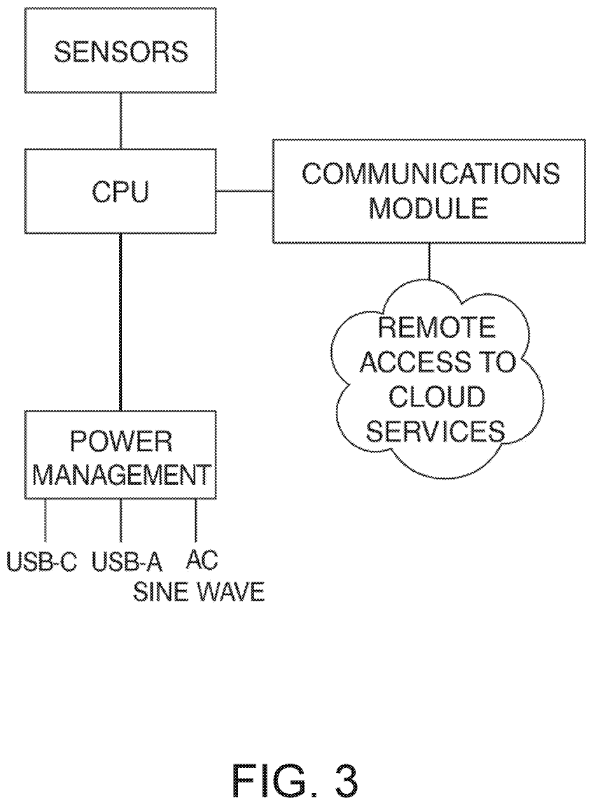

FIG. 3 is a schematic block diagram illustrating exemplary functional subsystems. The CPU receives input from an array of environmental sensors, preferably including a gyroscope, accelerometer, proximity sensor, and lidar unit. The processor preferably coordinates output power distribution via a power management controller to supply electricity to USB-C fast charging ports, USB-A ports, and dual AC sine wave outputs. Communications modules are preferably integrated on a network board and enable connectivity via 5G cellular, Wi-Fi, Bluetooth, LoRaWAN, satellite, and GPS systems. The CPU preferably is also connected to cloud services 38 for remote diagnostics and software updates, app control and its operating systems interaction.

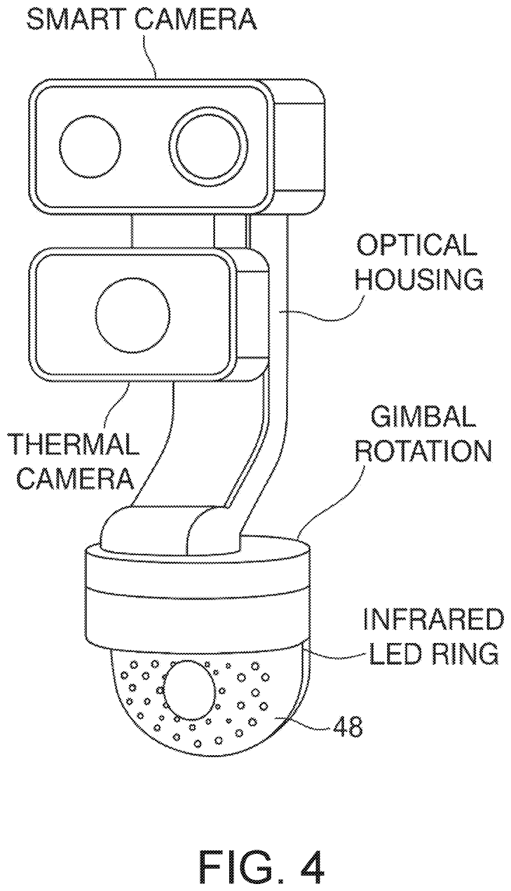

FIG. 4 shows an exemplary mounted camera subsystem. A dual-function imaging system preferably may include a detachable smart camera and a detachable thermal camera both positioned within a protective optical housing. These imaging units preferably are supported by object recognition and weapons detection algorithms processed locally by the CPU. The cameras preferably are mounted on a rotating gimbal to allow flexible directional orientation and infrared LEDs 48 preferably surround the smart camera for night vision capabilities.

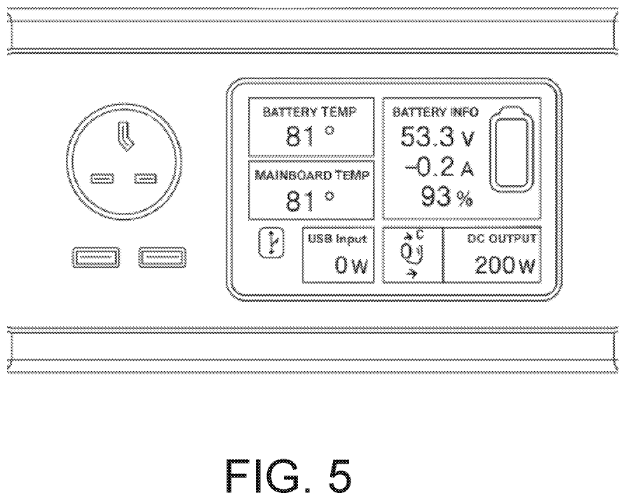

FIG. 5 illustrates an exemplary user interface and system indicators. The LCD display preferably provides real-time readouts for battery status, active connections (Wi-Fi, satellite, Bluetooth), camera activation, and AI alerts. Capacitive control buttons and a microphone/speaker grille for two-way audio functionality are preferably also provided, for example below the screen. An LED light bar may be integrated along the upper housing with programmable brightness and SOS pulse modes.

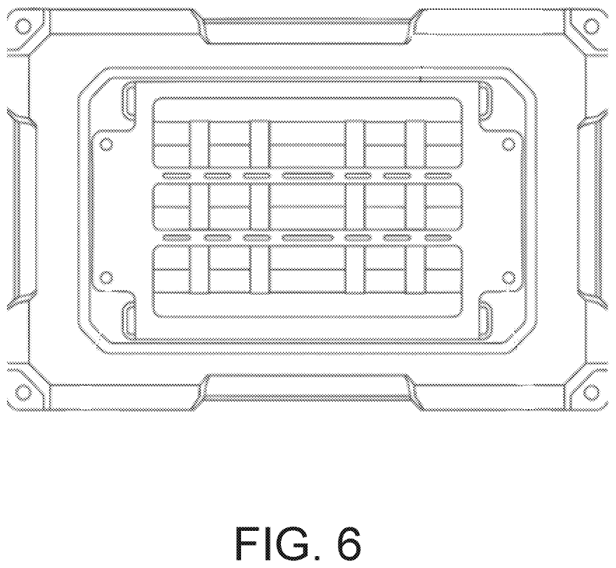

FIG. 6 shows the underside and mounting interface of an exemplary device. The base preferably incorporates a MOLLE-compatible rack system enabling connection to backpacks, vests, drones, vehicles, aircraft, and watercraft. A tray, preferably made of an aluminum alloy, preferably may support quick-release latches that interface with mounting platforms. Multiple anchor points preferably allow for secure attachment under vibration or extreme movement.

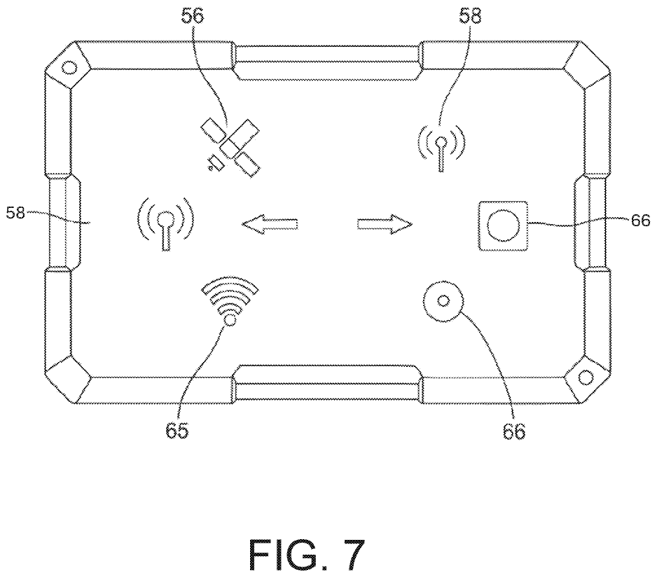

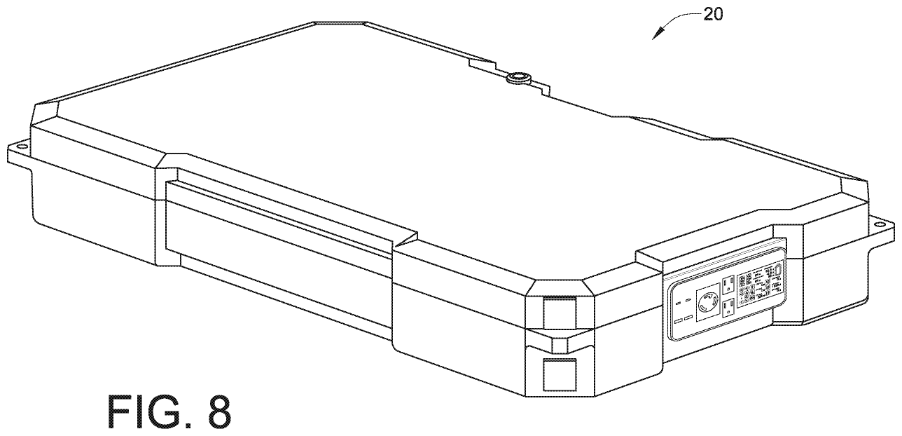

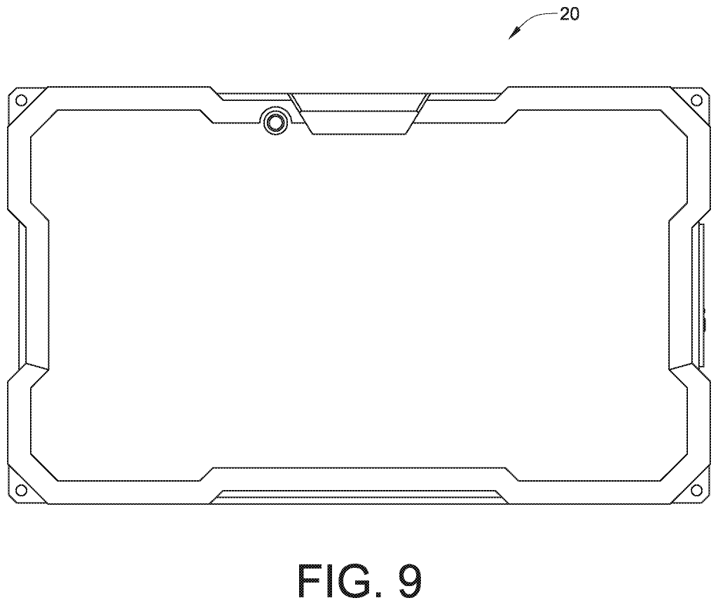

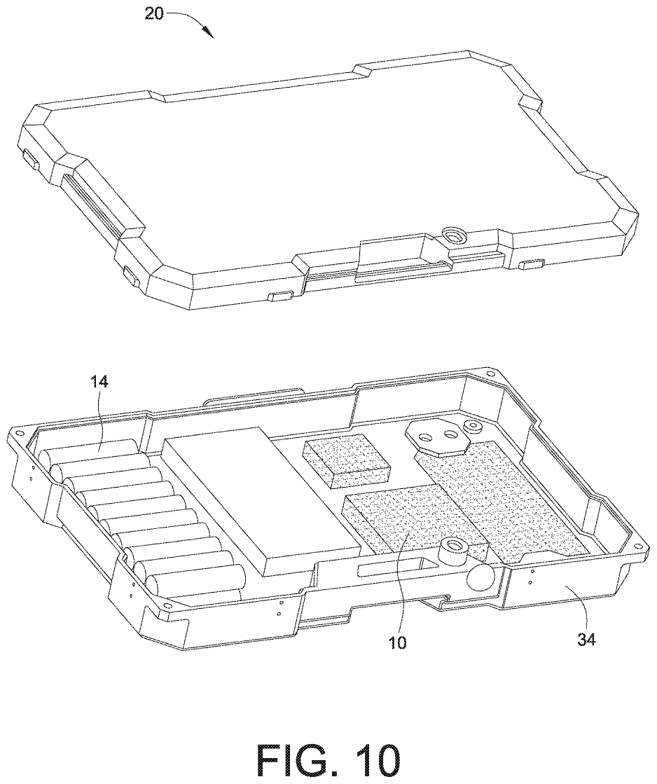

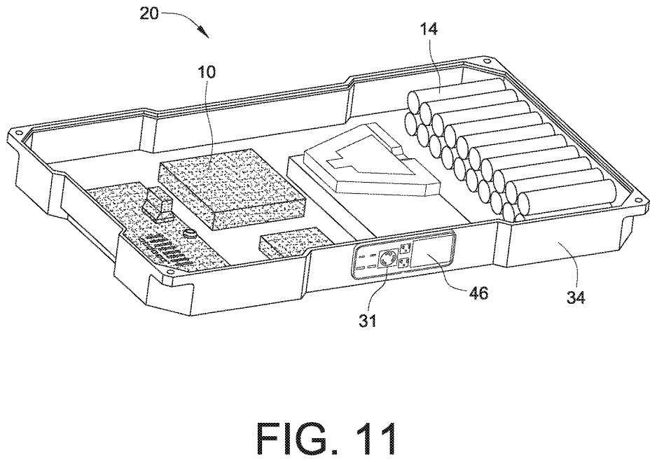

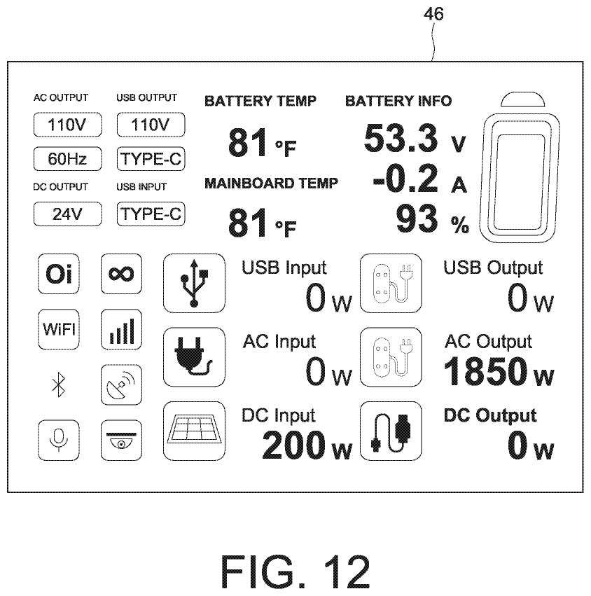

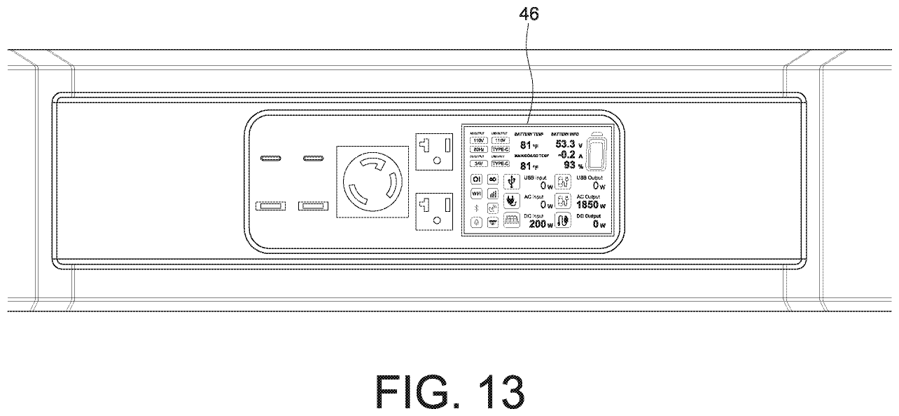

FIG. 7 provides an exemplary top-down schematic of antenna and sensor distribution. A satellite antenna 56, cellular antenna 58, Wi-Fi antenna 65, and GPS module preferably are radially spaced to minimize signal interference. Environmental sensors 66 preferably are internally arranged to maximize spatial awareness and ventilation ports ensure airflow through the internal fan and HVAC module. Thermal shielding preferably surrounds key power and logic modules to maintain optimal operational temperatures. Additional embodiments of the device are illustrated in FIGS. 8-13.

In one embodiment, the device can connect to companion apps for extended functionality and remote access. Wireless repeaters may be daisy-chained to extend Wi-Fi range, and accessory modules can be added to support further data acquisition, remote control, or edge computing expansion. The unit remains functional in temperatures between −10° C. and 40° C. and is operable in both humid and arid environments.

As can be appreciated, the portable device may be IP67 waterproof compliant. In one embodiment, it may include a protective coating for water-resistance or water-proofing. In one embodiment, the device 10 may be IP67 compliant. For example, the device 10 may include a polymeric coating formed using a continuous plasma comprising a compound of CH₂═C(R₁)—COO—R₂, where R₁ includes —H or —CH₃; and where R₂ includes —(CH₂)₂—(CF₂)m-CF₃ and m is 3 or 5, as disclosed in U.S. Pat. No. 8,852,693, whose contents are incorporated by reference in their entirety.

Artisans would appreciate that other commercially available compounds may be used for forming a polymeric coating on the surface of the device 10. In one embodiment, the protective coating has a thickness between about 250 nm and about 500 nm. In one embodiment, the protective coatings may have an oleophobicity level of about at least 5, suitably between about level 5 to about level 10, including every level therebetween, such as about levels 5, 6, 7, 8, 9 or 10. Additionally, the coating can provide a water contact angle of at least 100°. In one aspect, the coating can provide a water contact angle between about 100° to about 120°. Such characteristics of the coating can help protect against pollutants and contamination, including water or moisture contamination.

The coating material may also be an antimicrobial coating. As will be appreciated by those skilled in the art, antimicrobial coatings may include additives such as silver, zinc, tin, mercury, lead, iron, cobalt, nickel, manganese, arsenic, antimony, bismuth, barium, cadmium, and chromium. Exemplary antimicrobial coatings may include, for example, those disclosed in U.S. Publ. Nos. US20060222845, US20070259307, US20110206817, US20090202656, US20090182337, and US20110311591, and in U.S. Pat. Nos. 8,080,028, 6,238,686, 5,770,255, 5,753,251, 5,681,575, 8,084,132, 7,884,089, 7,625,579, 7,955,636, 5,066,328, 8,124,169, 4,933,178, 8,066,854, 6,929,705, 5,997,815, 7,282,214, 7,976,863, 6,514,517, 5,238,749, 8,137,735, 6,592,814, 8,172,395, 7,402,318, 8,133,423, 5,853,745, 6,565,913, 8,178,120, 6,361,567, 5,756,145, 7,641,912, 6,900,265 and 5,244,667, each of which is incorporated by reference herein in its entirety.

The coating material may also be a fire-resistant coating. Suitable fire-resistant coatings include, for example, those disclosed in U.S. Pat. Nos. 5,322,555, 5,236,773, U.S. Publ. No. US20060083878, and PCT Appl. No. PCT/EP2000/004914, each of which is incorporated by reference herein in its entirety.

The coating material may also be a scratch resistant coating. Suitable scratch resistant coatings may include, for example, those disclosed in U.S. Pat. Nos. 7,867,602, 5,837,362, 6,025,059, 7,264,669, 7,115,050, 6,916,368, 6,020,419, 6,803,408, 6,835,420, 6,759,478, 8,163,357, 6,387,519, 7,053,149, 7,662,433, and 7,871,690, and U.S. Publ. Nos. US20120100380, US20110097574, US20100119802, US20110058142, US20120121845, US20120003483, and US20110151218, each of which is incorporated by reference herein in its entirety.

Although the various inventive aspects are herein disclosed in the context of certain preferred embodiments, implementations, and examples, it will be understood by those skilled in the art that the present invention extends beyond the specifically disclosed embodiments to other alternative embodiments and/or uses of the invention and obvious modifications and equivalents thereof. In addition, while a number of variations of the inventive aspects have been shown and described in detail, other modifications, which are within their scope will be readily apparent to those of skill in the art based upon this disclosure.

In another embodiment, the device may be optimized for disaster response operations. It may include an integrated satellite uplink module configured for emergency channel priority secured access, as well as real-time geolocation tagging of audio-visual logs. In such deployments, rescue workers could rely on the device to generate mesh Wi-Fi coverage across remote or devastated areas while simultaneously powering communication tools and body-worn sensors.

In another embodiment, the device may be mounted on a small unmanned aerial vehicle (UAV) or drone platform using the MOLLE-compatible tray system. The UAV-deployed unit may operate as a mobile relay node for surveillance data, atmospheric monitoring, and extended line-of-sight communications between field teams and command centers. The battery and inverter systems may be adapted to optimize weight and cooling during airborne operations.

In another embodiment, the device may be deployed for marine or maritime security operations, where waterproofing and buoyancy features are critical. The device may include an optional tether and floating beacon for recovery, as well as salt-resistant coating layers. It may power sonar or submersible drone systems, provide backup power to onboard navigational systems, and act as a satellite-connected distress beacon in emergencies.

In another embodiment, the device may be configured as a mobile command node in remote field research settings such as archaeological digs or environmental monitoring stations. The onboard AI may process input from scientific sensors, including environmental chemical detection or seismographic data. Output power can support microscopes, laptops, radios, or field sample refrigeration units. Data logs may be streamed via satellite or stored locally for post-field analysis.

In yet another embodiment, the device may serve a civilian consumer use case, such as for recreational overland travelers, campers, or digital nomads. The system could integrate entertainment and productivity features, such as high-speed internet access, solar charging compatibility, Bluetooth speaker arrays, and drone charging ports. AI modules may be optimized to support safety monitoring, real-time language translation, or smart environmental feedback.

These example embodiments are not limiting but illustrate the flexible and modular nature of the invention across a wide range of professional and personal use environments. Each embodiment may include additional, fewer, or alternative components and functionalities depending on mission requirements or user preference.

In one embodiment, the device may be adapted for construction site management and industrial monitoring. The unit could support jobsite Wi-Fi coverage, power up hand tools or tablets, and operate real-time monitoring cameras that provide security or visual documentation of construction progress. Environmental sensors could also alert users to potential hazards such as gas leaks, excessive vibration, or unauthorized personnel.

In another embodiment, the device may be deployed in agricultural automation and precision farming. The unit could act as a central communications and data hub for IoT-enabled farm sensors monitoring soil moisture, nutrient levels, weather, and crop growth. It may power irrigation controllers, relay satellite data for autonomous farming equipment, and analyze sensor data locally using embedded AI.

In another embodiment, the device may be used for military forward operating base (FOB) support. Its rugged construction and rapid-deploy form factor make it suitable for integration into mobile base camps, outposts, and field command vehicles. The unit could provide power, encrypted communications, thermal and visual surveillance, and active threat detection. Detachable antenna arrays may be used to maintain signal security and range.

In one embodiment, the device may support telemedicine and remote health services, particularly in low-resource or post-disaster environments. The system could be configured with interfaces for medical diagnostic tools, imaging devices, and satellite communication with health professionals. AI algorithms may assist in triage or diagnostics using image and sound inputs from sensors or patient-worn devices.

In one embodiment, the device may be utilized in border security and perimeter surveillance operations. Mounted on tripods, poles, or mobile patrol vehicles, the unit could provide persistent surveillance using its thermal and smart cameras, while also serving as a local data processing hub for AI-based threat identification. Its integrated communications systems allow it to securely transmit alerts and video to command centers in real time, even in remote or infrastructure-sparse regions. The rugged design and autonomous power capabilities make it ideal for long-duration deployment in harsh terrain or along national borders.

These additional example embodiments demonstrate the invention's adaptability across domains ranging from civil engineering and agriculture to defense, healthcare, and security. The modular design allows integration of mission-specific sensors, communication protocols, and power profiles. In all such configurations, the core features of ruggedness, power management, environmental sensing, artificial intelligence, and global communications remain central to the invention.

As such, this disclosure is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

Further, all claim terms should be interpreted in their most expansive forms so as to afford the applicant the broadest coverage legally permissible. Although the embodiments have been described with reference to the drawings and specific examples, it will readily be appreciated by those skilled in the art that many modifications and adaptations of the processes, methods and apparatuses described herein are possible without departure from the spirit and scope of the embodiments as claimed herein. Thus, it is to be clearly understood that this description is made only by way of example and not as a limitation on the scope of the embodiments as claimed below.

What is claimed is:

1. A portable multifunctional device comprising:
a housing enclosing a rechargeable battery with at least one kilowatt-hour capacity;
a central processing unit (CPU) with onboard memory and logic circuitry;
a power interface including AC and DC output ports, USB ports, and Power-over-Ethernet (POE) connectors; and
a communications module configured to support at least one of cellular, Wi-Fi, Bluetooth, satellite, GPS, and LoRaWAN connectivity.

2. The device of claim 1, wherein the AC power interface includes a sine wave inverter rated at 220 watts and 30 amps.

3. The device of claim 1, further comprising one or more USB-C ports configured to deliver at least 100 watts each.

4. The device of claim 1, wherein the communications module includes a 5G cellular modem, a Wi-Fi antenna, a GPS receiver, a satellite uplink unit, and a LoRaWAN transceiver.

5. The device of claim 1, further comprising a detachable camera module selected from the group consisting of smart optical cameras and thermal imaging sensors.

6. The device of claim 5, further comprising an onboard artificial intelligence engine configured to perform image recognition, threat detection, or classification using data from the camera module.

7. The device of claim 1, further comprising an array of environmental sensors selected from the group consisting of motion sensors, gyroscopes, accelerometers, proximity sensors, infrared sensors, and lidar modules.

8. The device of claim 1, wherein the housing is formed from a combination of polycarbonate, Kevlar, and D30 foam and is sealed to be waterproof and buoyant.

9. The device of claim 1, wherein the housing includes a MOLLE-compatible mounting system for affixing the device to a backpack, vest, vehicle, or stationary structure.

10. A field-deployable portable power and surveillance unit comprising:
a power subsystem including a lithium-based rechargeable battery, inverter, and charging input circuitry;
a lighting module integrated into the housing and operable in general illumination and emergency strobe modes;
a graphical display and user interface configured to show system diagnostics, network status, and alerts; and
a fan and HVAC thermal regulation system to maintain internal temperatures within a functional operating range.

11. The unit of claim 10, wherein the HVAC system maintains operability between −10° C. and 40° C. and stores safely between −20° C. and 45° C.

12. The unit of claim 10, wherein the lighting module provides SOS signaling visible from at least 50 meters.

13. The unit of claim 10, further comprising a detachable wireless repeater for mesh networking or daisy-chained range extension.

14. The unit of claim 10, further comprising an integrated speaker and microphone configured for two-way communication and remote audio capture.

15. A portable electronic device for remote diagnostics and communication, comprising:
a sealed, ruggedized enclosure;
a central processing unit configured to perform artificial intelligence computations onboard;
a multi-mode communications interface including at least satellite, Wi-Fi, and cellular connectivity;
a set of onboard sensors and visual imaging systems; and
a coating applied to the exterior housing for at least one of water-resistance, antimicrobial protection, fire resistance, or scratch resistance.

16. The device of claim 15, wherein the coating comprises a polymer formed from CH₂═C(R₁)—COO—R₂, where R₁ includes —H or —CH₃ and R₂ includes (CH₂)₂ (CF₂)m-CF₃, where m is 3 or 5.

17. The device of claim 15, wherein the coating has a thickness between about 250 nm and 500 nm and provides a water contact angle of at least 100°.

18. The device of claim 15, wherein the coating is antimicrobial and comprises additives selected from silver, zinc, copper, and tin.

19. The device of claim 15, wherein the coating provides a scratch resistance rating as defined in ASTM D3363 or equivalent test standard.

20. The device of claim 15, wherein the enclosure and its internal components are configured to withstand airborne, marine, or mobile platform deployment.
